(19) United States
(12) Patent Application Publication
(10) Pub. No.: US 2008/0299991 A1
(43) Pub. Date: Dec. 4, 2008

(54) METHOD FOR LOCATING A MOBILE UNIT

(76) Inventors: Mark E. Newbury, Hillsborough, NJ (US); Hong Yang, Ledgewood, NJ (US)

Correspondence Address: MARK W. SINCELL;Williams, Morgan & Amerson, P.C., Suite 1100, 10333 Richmond, Houston, TX, 77042, US

(21) Appl. No.: 11/757,634

(22) Filed: Jun. 4, 2007

(51) Int. Cl. H04Q 7/20

(52) U.S. Cl. 455/456.2

(57) ABSTRACT

The present invention provides a method of locating a mobile unit. The method may include storing, at a location outside of a mobile unit, information indicative of a last known location of the mobile unit and the associated time stamp. The method may also include transmitting, from a mobile unit, information indicative of the last known location of the mobile unit. The last known location is determined using global positioning system satellite signals.

### BACKGROUND OF THE INVENTION

1. Field of the Invention

This invention relates generally to communication systems, and, more particularly, to wireless communication systems.

2. Description of the Related Art

Conventional wireless communication systems include numerous base stations that are used to provide wireless connectivity to associated geographic regions known as cells. Mobile units in a cell may connect to the wireless communication system by establishing a wireless communication link to the base station in the cell. A user of the mobile unit may therefore place calls over the wireless communication link to other users that are connected to the wireless communication system. One particularly important type of call that may be placed by the user of a mobile unit is an emergency E911 call that is typically placed when the user is in distress or is a witness to an emergency situation and is attempting to call for assistance. Assistance may be dispatched to the user's location as soon as this location is determined. However, in contrast to stationary telephony devices that are deployed in a location that may be easily determined based on the telephone number associated with the telephony device, mobile units are not associated with any particular location and, in some cases, may be thousands of miles away from the home address associated with the user of the mobile unit.

The Federal Communications Commission (FCC) of the United States Government has issued a mandate that states that service providers should be able to determine the location of a mobile unit placing an E911 call to within less than 50 m for 67% of E911 calls and within 150 m for 95% of E911 calls. Mobile units that incorporate Global Positioning System (GPS) functionality can typically be located to within a few meters if they are able to receive signals from four or more GPS satellites. Consequently, service providers are likely to be able to satisfy the FCC mandate for E911 calls placed by GPS-enabled mobile phones when they are operating outdoors. However, GPS cannot be used to locate mobile phones that are not GPS-enabled or to locate GPS-enabled mobile phones that are operating indoors or otherwise prevented from receiving signals from GPS satellites.

Service providers can determine the location of a mobile unit using signals provided by multiple base stations. For example, multiple base stations can measure round-trip time delays for signals transmitted to a mobile unit. The round-trip time delays can be used to estimate the distance between each of the base stations and the mobile unit and these distance estimates can be used to estimate the location of the mobile unit by triangulation. However, the accuracy of positions determined by triangulation is limited by a number of factors, including the effects of multi-path environments that typically occur in wireless communication systems and the number of base stations that are within the communication range of the mobile. Typically, a mobile can only communicate with one or two base stations, which is not enough for a true triangulation. Consequently, triangulation of base station signals can only determine the location of a mobile unit to within approximately several hundred meters. Thus, service providers are currently unable to satisfy the FCC mandate for E911 calls placed by mobile phones that are not GPS-enabled. Service providers are also currently unable to satisfy the FCC mandate for E911 calls placed by GPS-enabled mobile phones that are operating indoors or are otherwise prevented from receiving signals from GPS satellites.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for locating a mobile unit. The method may include storing, at a location outside of a mobile unit, information indicative of a last known location of the mobile unit. The method may also include transmitting, from a mobile unit, information indicative of the last known location of the mobile unit. The last known location is determined using global positioning system satellite signals.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a wireless communication system, in accordance with the present invention;

FIG. 2 conceptually illustrates a second exemplary embodiment of a wireless communication system, in accordance with the present invention; and

FIG. 3 conceptually illustrates one exemplary embodiment of a method of determining a location of a mobile unit, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i. e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

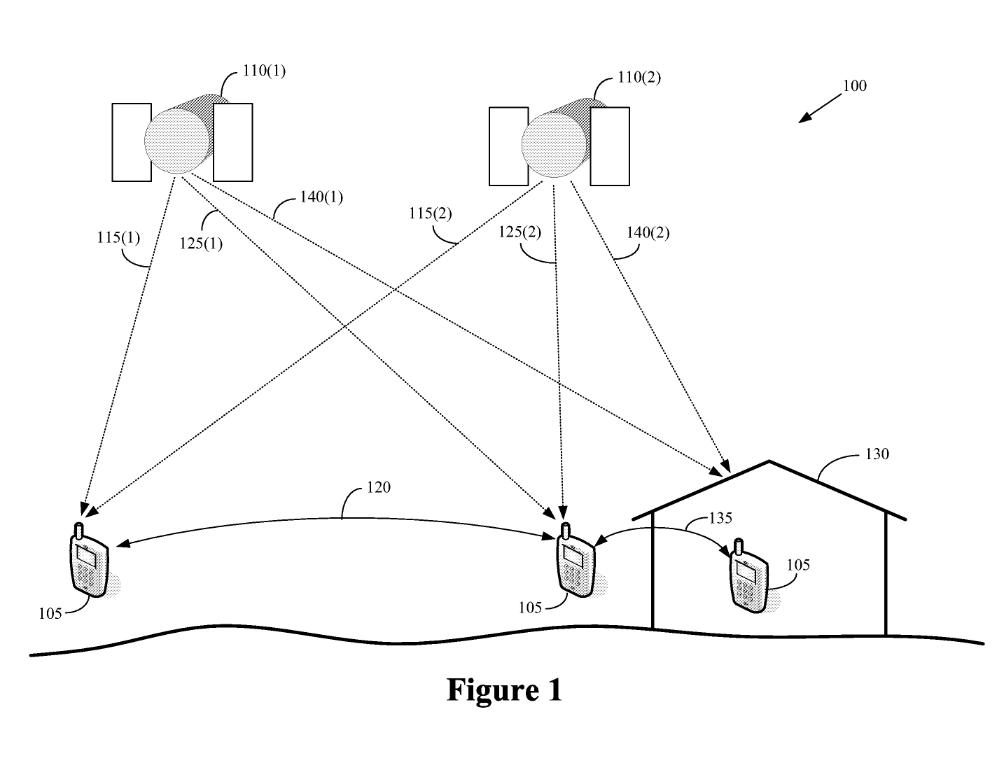

FIG. 1 conceptually illustrates a first exemplary embodiment of a wireless communication system 100. In the illustrated embodiment, wireless connectivity is provided to a geographic region including a mobile unit 105. Exemplary mobile units 105 include cellular telephones, personal data assistants, smart phones, text messaging devices, pagers, network interface cards, notebook computers, desktop computers, and the like. The wireless connectivity may be provided using one or more base stations, base station routers, access points, access networks, and the like. In the interest of clarity, the device or devices that are used to provide wireless connectivity are not shown in FIG. 1. The wireless connectivity may be provided according to any combination of wired and/or wireless communication standards and/or protocols. For example, wireless connectivity may be provided to the mobile unit 105 using standards and/or protocols determined by the Third Generation Partnership Project (3GPP, 3GPP2).

The wireless communication system 100 also includes one or more satellites 110(1-2) that are capable of providing positioning signals, such as Global Positioning System (GPS) signals. The indices (1-2) may be used to indicate individual satellites 110(1) or subsets thereof. However, the indices may be dropped when referring to the satellites 110 collectively. This convention may also be applied to other elements shown in the drawings and indicated by a numeral and one or more distinguishing indices. Although two satellites 110 are shown in FIG. 1, persons of ordinary skill in the art having benefit of the present disclosure should appreciate that the present invention is not limited to any particular number of satellites 110. For example, satellites 110 that are deployed as part of a Global Positioning System may be deployed so that the mobile unit 105 is able to receive signals from four or more satellites 110. Mobile units 105 that can receive signals from the satellites 110 are sometimes referred to as being able to “see” the satellites 110.

The mobile unit 105 includes functionality that enables the mobile unit 105 to determine its location using signals provided by the satellites 110. In the illustrated embodiment, the mobile unit 105 is initially located outdoors in a location that permits the mobile unit 105 to see the satellites 110. Thus, the mobile unit 105 can receive the positioning signals 115 that are transmitted by the satellites 110. The mobile unit 105 may therefore be able to determine its current location using the positioning signals 115. For example, the mobile unit 105 may be able to determine its current latitude and longitude using GPS signals provided by the satellites 110. Techniques for determining a location based upon positioning signals 115 are known in the art and in the interest of clarity only those aspects of determining a location based upon positioning signals 115 that are relevant to the present invention will be discussed herein. The mobile unit 105 may then store the location determined using the positioning signals 115. In one embodiment, the mobile unit 105 may also determine and store information indicating a time at which the current location was determined.

The mobile unit 105 may move to a different position, as indicated by the arrow 120. Since the mobile unit 105 can still see the satellites 110 at the new location, the mobile unit 105 may determine its new location using positioning signals 125 provided by the satellites 110. The mobile unit 105 may store the new location in a manner that indicates that this location is the current location of the mobile unit 105. In one embodiment, the mobile unit 105 may also determined and store information indicating a time at which the new location was determined. Although the positioning signals 125 are provided by the same satellites 110 as the positioning signals 115, persons of ordinary skill in the art having benefit of the present disclosure should appreciate that the present invention is not so limited. For example, movement of the mobile unit 105 may result in some of the satellites 110 becoming invisible to the mobile unit 105 and other satellites 110 becoming visible to the mobile unit 105. Consequently, in some embodiments, the specific satellites 110 that provide the positioning signals 125 may change over time.

In the illustrated embodiment, the mobile unit 105 then moves to a location inside of a building 130, as indicated by the arrow 135. The building 130 obscures the positioning signals 140 transmitted by the satellites 110 so that the mobile unit 105 cannot see the satellites 110. Consequently, the mobile unit 105 determines that it is unable to see the satellites 110 and is therefore unable to determine its location based upon the positioning signals 140. In one embodiment, the mobile unit 105 determines that it is unable to determine its location based upon the positioning signals 140 when it is unable to detect the positioning signals 140 from any satellite 110. However, the present invention is not limited to this particular embodiment. In alternative embodiments, the mobile unit 105 may use other criteria to determine when it is unable to determine its location based upon positioning signals 140. For example, the mobile unit 105 may determine that the number of visible satellites 110 is too small to permit an accurate determination of its location and may therefore determine that it is unable to determine its location based upon the positioning signals 140. For another example, the mobile unit 105 may determine that the signal strength of the positioning signals 140 is too small to permit an accurate determination of its location.

The positioning signals 140 may also be obscured or unavailable to the mobile unit 105 for other reasons. For example, the mobile unit 105 may be placed inside of a briefcase or carried in a car that obscures the positioning signals 140. For another example, the functionality within the mobile unit 105 that permits the mobile unit 105 to determine its location using the positioning signals 140 may become temporarily and/or permanently disabled. Accordingly, the mobile unit 105 may determine that it is unable to determine its location using positioning signals 140 for these and/or other reasons. Persons of ordinary skill in the art having benefit of the present disclosure should appreciate that the present invention is not limited to any particular cause of the mobile unit 105 becoming unable to determine its location using the positioning signals 140.

The mobile unit 105 may designate the location that was most recently determined based upon positioning signals 115, 125 as the last known position when the mobile unit 105 determines that it is no longer able to determine its current location based upon positioning signals provided by the satellites 110. In the illustrated embodiment, the mobile unit 105 designates the location determined based upon the positioning signals 125 as the last known position when the mobile unit 105 moves inside the building 130 and determines that it is unable to receive the positioning signals 140. The last known position may be stored within the mobile unit 105 and transmitted to another entity in the wireless communication system 100, where the last known position may also be stored, as discussed in more detail below. The last known position may then be used to locate the mobile unit 105 if the mobile unit 105 is used to place an emergency call.

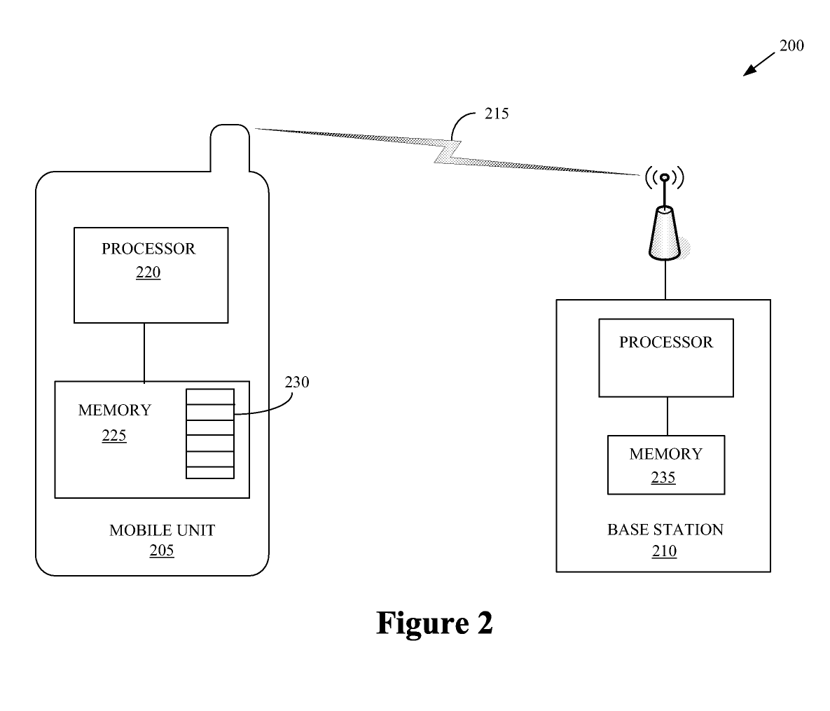

FIG. 2 conceptually illustrates a second exemplary embodiment of a wireless communication system 200. The second exemplary embodiment of the wireless communication system 200 includes a mobile unit 205 that may communicate with a base station 210 over a wireless communication link 215. The mobile unit 205 includes a processing unit 220, which may be used to implement functionality that enables the mobile unit 205 to determine its location using satellite positioning signals, such as GPS signals, as described herein. Information indicating the location of the mobile unit 205 may be stored in a memory 225. For example, the memory 225 may include a register or buffer 230 that is used to store latitudes and longitudes that indicate locations of the mobile unit 205 that are determined based upon GPS signals. Each location may be stored in a slot in the buffer 230, along with information indicating the time at which the location was determined. The locations may then be sorted so that the most recently determined location is at the top of the buffer 230. If the mobile unit 205 becomes unable to determine its current location based upon satellite positioning signals, the most recently determined location may be designated as the last known location of the mobile unit 205. Information indicating the last known location, as well as the time at which the last known location was determined, may also be stored in the memory 225.

The mobile unit 205 may then transmit information indicating the last known location to the base station 210. In one embodiment, the mobile unit 205 transmits the information indicating the last known location in response to determining that the mobile unit 205 is unable to determine its location based upon satellite positioning signals. In another embodiment, the mobile unit 205 may transmit the information indicating the last known location in response to the mobile unit 205 placing an emergency call. The base station 210 may store this information in a memory 235 and/or transmit it to another entity within the wireless communication system 200. For example, if the mobile unit 205 places an emergency call, a service provider may transmit a request to access the current location of the mobile unit 205. If the mobile unit 205 is not able to determine its current location based upon satellite positioning signals, the last known location of the mobile unit 205 may then be transmitted to the service provider.

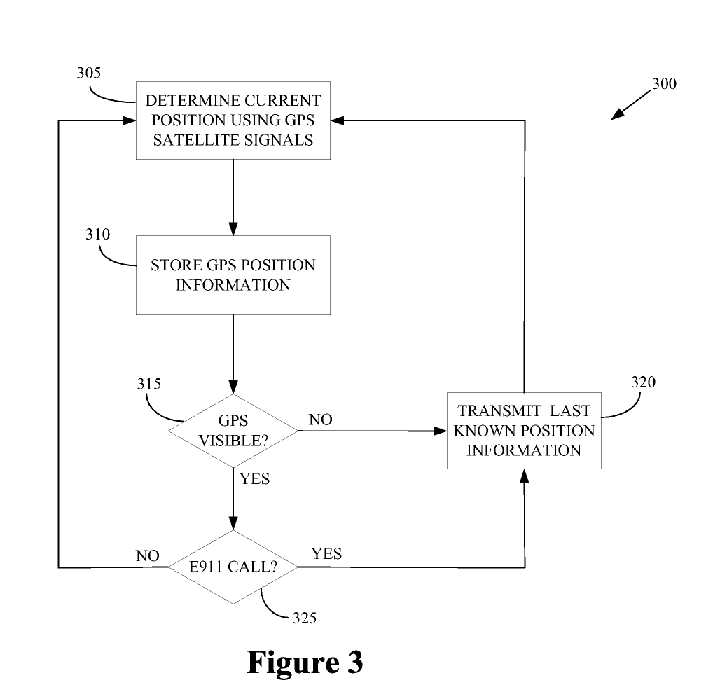

FIG. 3 conceptually illustrates one exemplary embodiment of a method 300 of determining a location of a mobile unit. In the illustrated embodiment, a mobile unit determines (at 305) a current position using satellite positioning signals, such as GPS signals. The mobile unit may then store (at 310) information indicating the position determined using the satellite positioning signals. For example, the mobile unit may store (at 310) a latitude and a longitude associated with the current location of the mobile unit. In one embodiment, the mobile unit may also store (at 310) a timestamp indicating the time at which the current location was determined (at 305). The mobile unit may then determine (at 315) whether it can still see the satellite positioning signals. For example, the mobile unit may determine (at 315) whether or not it is still receiving GPS signals from a sufficient number of satellites to determine its current location within a selected tolerance. The specific tolerance is a matter of design choice and not material to the present invention.

If the mobile unit determines (at 315) that it cannot see any satellite positioning signals, or cannot see or acquire a sufficient number of sufficiently strong satellite positioning signals to determine its position within a selected tolerance, then the mobile unit may transmit (at 320) information indicating its last known position to the wireless communication system. However, the mobile unit may not, in all embodiments, transmit (at 320) its last known position in response to determining that it is unable to determine its location based upon satellite positioning signals. In one alternative embodiment, the mobile unit may identify and store the last known position in response to determining that it is unable to determine its location based upon satellite positioning signals.

The mobile unit may also determine (at 325) whether or not an emergency call is being placed. If no emergency call is being placed and the satellite positioning signals are visible to the mobile unit, then the mobile unit may continue to determine (at 305) its current location using the satellite positioning signals. However, if the mobile unit determines (at 325) that an emergency call is being placed, then the mobile unit may transmit (at 320) information indicating its last known position. However, the mobile unit may not, in all embodiments, transmit (at 320) information indicating its last known position in response to an emergency call being placed. For example, the mobile unit may know that it has already transmitted (at 320) this information to the wireless communication system and therefore it may not be necessary to transmit this information again. Alternatively, the mobile unit may transmit (at 320) the information indicating its last known position in response to determining (at 315) that is unable to determine its location based on satellite positioning signals and in response to determining (at 325) that an emergency call is being placed. This approach may add redundancy that may improve the likelihood that the last known position information is conveyed to the wireless communication system when an emergency call is placed.

Embodiments of the techniques described herein may have a number of advantages over conventional practice. In a conventional wireless communication system, mobile units that are unable to see satellite positioning signals, or are unable to acquire a sufficient number of sufficiently strong satellite positioning signals, are forced to use alternative means of locating the mobile unit. For example, the wireless communication system may use base station triangulation to locate the mobile units. However, these techniques may not provide sufficient accuracy to meet current and/or future FCC mandates. Utilizing the last known location of a mobile unit that was determined based upon satellite positioning signals may provide a much more accurate estimate of the current location of the mobile unit. For example, if the mobile unit is unable to determine its position based on satellite positioning signals because the user of the mobile unit has entered a building, the last known location may be more accurate than location estimates determined based upon base station triangulation, particularly when the footprint of the building is much smaller than the typical (several hundred meter) error expected for base station triangulation. The accuracy of the last known location as an indicator of the current location of the mobile unit may improve when the elapsed time since the time the last known location was recorded is shorter.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
storing, at a location outside of a mobile unit, information indicative of a last known location of the mobile unit, the last known location being determined using global positioning system satellite signals.

2. The method of claim 1, comprising receiving information indicative of the last known location of the mobile unit, said at least one location being determined by the mobile unit using global positioning system satellite signals received by the mobile unit.

3. The method of claim 2, wherein receiving the information indicative of the last known location of the mobile unit comprises receiving the information in response to the mobile unit determining that it can no longer determine its location to within a selected accuracy using the global positioning system satellite signals.

4. The method of claim 3, wherein receiving the information indicative of the last known location of the mobile unit comprises receiving the information in response to the mobile unit determining that the global positioning system satellite signals have been obscured.

5. The method of claim 2, wherein receiving the information indicative of the last known location of the mobile unit comprises receiving the information in response to the mobile unit placing an emergency call.

6. The method of claim 1, wherein storing the information indicative of the last known location of the mobile unit comprises storing information indicating the time that the last known location was determined.

7. The method of claim 1, comprising providing, to a dispatcher, the stored information indicative of the last known location of the mobile unit in response to a request from the dispatcher.

8. A method, comprising:
transmitting, from a mobile unit, information indicative of a last known location of the mobile unit determined using global positioning system satellite signals.

9. The method of claim 8, comprising determining, at the mobile unit, the last known location of the mobile unit based upon global positioning system satellite signals received by the mobile unit.

10. The method of claim 8, comprising determining that the mobile unit can no longer be located using global positioning system satellite signals.

11. The method of claim 10, wherein determining that the mobile unit can no longer be located using global positioning system satellite signals comprises determining that the mobile unit can no longer determine its location to within a selected accuracy using the global positioning system satellite signals.

12. The method of claim 10, wherein determining that the mobile unit can no longer determine its location to within the selected accuracy comprises determining that the global positioning system satellite signals have been obscured from the mobile unit.

13. The method of claim 10, wherein transmitting the information indicative of the last known location of the mobile unit comprises transmitting the information in response to determining that the mobile unit can no longer be located using global positioning system satellite signals.

14. The method of claim 8, wherein transmitting the information indicative of the last known location of the mobile unit comprises transmitting the information in response to the mobile unit placing an emergency call.

15. The method of claim 8, wherein transmitting the information indicative of the last known location of the mobile unit comprises transmitting information indicative of a time that the last known location was determined.
